(19) United States
(12) Patent Application Publication
(10) Pub. No.: US 2005/0030273 A1
(43) Pub. Date: Feb. 10, 2005

(54) Current drive system with high uniformity reference current and its current driver

(75) Inventors: Jun-Ren Shih, Changhua County (TW); Chien-Ru Chen, Pingtung County (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 10/689,063

(22) Filed: Oct. 21, 2003

(30) Foreign Application Priority Data
Aug. 6, 2003 (TW) 92121468

(51) Int. Cl. G09G 3/36

(52) U.S. Cl. 345/94

(57) ABSTRACT

A current drive system with high uniformity reference current and its current driver are disclosed. Each current driver has a current reference generator unit and a current mirror unit, wherein the current reference generator unit has a current regulating parameter and the current mirror unit has a current copy parameter such that the current reference generator unit generates a current based on the current regulating parameter and the current mirror unit generates a reference current for current reference generator unit of next current driver as an input current.

### BACKGROUND OF THE INVENTION

1. Field of the Invention

The present invention relates to a data driver (source driver) and, more particularly, to a current driver system with high uniformity reference current adapted for flat panel displays, and its current driver.

2. Description of Related Art

Technologies have originated from humanity chase for the ultimate goal of more safe and comfortable living. In daily life, image transmission brings a lot of funs to people in addition to digital communication function. Typical image transmission interface employs cathode ray tubes (CRTs) for display. However, the CRT may produce radiation and has a large volume. Therefore, CRTs are increasingly replacing by flat panel displays (such as liquid crystal displays (LCDs) and organic light-emitting diodes (OLEDs)).

FIG. 1 is a configuration of a typical flat panel display. In FIG. 1, the display essentially includes a display panel 11, source drivers 12, gate drivers 13 and a controller 14. The source drivers 12 and the gate drivers 13 essentially output required voltage to pixels on the display panel 11. The source drivers 12 are also referred to as data drivers to arrange data input. The gate drivers 13 determine the twisting condition and corresponding speed of liquid crystal (LC) cells in the display panel 11. In general, for a high resolution on the display panel 11, required number of the source drivers 12 and gate drivers 13 is increased so that the difficulty of keeping every source driver 12 on uniformity is increased.

Driving used by existing drivers can essentially be divided into voltage driving (e.g., LCDs) and current driving (e.g., OLEDs). In a voltage driving panel, drivers need the same reference voltage such that their analog output voltages are the same. In a current driving panel, drivers need the same reference current such that their output currents are the same, thus obtaining preferred frame uniformity.

FIG. 2 shows a schematic diagram of current-type source drivers. As cited, drivers 21, 22, 23 need the same reference current such that their output currents are the same. Reference current of each current-type source driver 21, 22, or 23 is generally generated by regulating corresponding control voltage (reference voltage) and input resistor (reference resistance) 211, 212 or 213. That is, a reference current equals to a reference voltage divided by a reference resistance.

However, control voltage can be provided by an external circuit or corresponding current-type source driver itself. In this case, control voltages for the current-type source drivers 21, 22, 23 may have certain difference. Further, for convenience of regulating the reference current, input resistors 211, 212, 213 are external in general. However, values of the input resistors are impossible to be identical, which can have a variance from about +/−1% to about +/−5%. Accordingly, reference currents for current-type source drivers 21, 22, 23 are different, which causes outputting different currents and thus presents uneven frames so that a uniformity requirement for a resolution over 6 bits cannot be met.

Therefore, it is desirable to provide improved current-type source drivers with the same reference current, to mitigate and/or obviate the aforementioned problems and obtain preferred uniform frames.

### SUMMARY OF THE INVENTION

The object of the present invention is to provide a current drive system with high uniformity reference current and its current driver, which can output the same current to obtain preferred display uniformity.

According to a feature of the present invention, a current drive system with high uniformity reference current is provided. The system includes a first current driver and at least one second current driver. The first current driver has a first reference current generator unit and a first current mirror unit. The first reference current generator unit generates a pre-stage reference current Iref and a first reference current I1, where I1=K1*Iref and K1 is a current regulating parameter of the first reference current generator unit. The first current mirror unit receives the first reference current I1 and accordingly generates a second reference current I2=K2*I1, where K2 is a current copy parameter of the first current mirror unit. The second current driver has a second reference current generator unit. The second reference generator unit receives the second reference current I2 and accordingly generates a third reference current I3=K3*I2, where K3 is a current regulating parameter of the second reference current generator unit and K2*K3=1.

According to another feature of the present invention, a current driver is provided to connect in series to a next current driver in order to form a current driving system, which provides an output current to drive a display panel. The current driver includes a reference current generator unit and a current mirror unit. The reference current generator unit generates a pre-stage reference current Iref and accordingly generates a first reference current I1=K1*Iref, where K1 is a current regulating parameter of the reference current generator unit. The current mirror unit inputs the first reference current I1 and accordingly generates a second reference current I2=K2*I1, where K2 is a current copy parameter of the current mirror unit. The second reference current I2 is inputted to the next current driver in order to generate a third reference current I3=K3*I2, where K3 is a current regulating parameter of reference current generator unit of the next current driver and K2*K3=1.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a system configuration of a typical flat panel display;

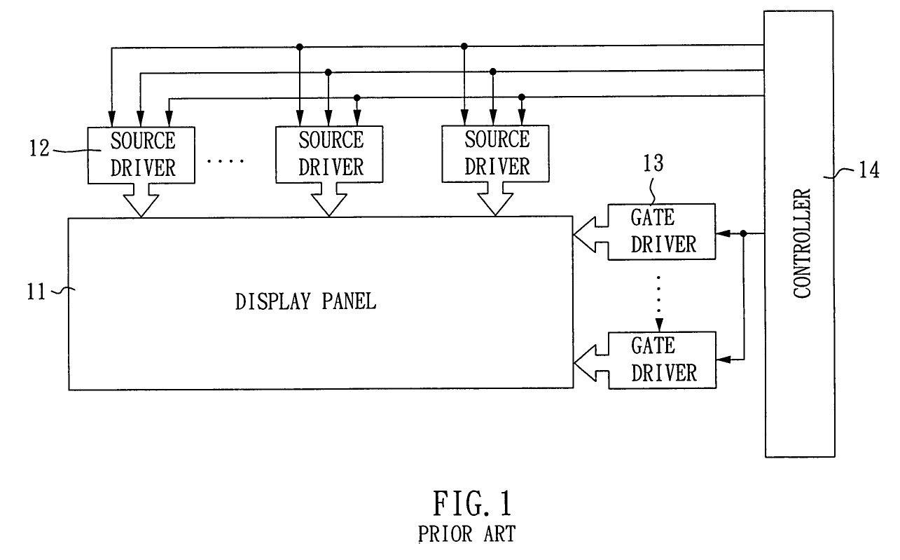

FIG. 2 is a schematic diagram of a typical current-type source driver;

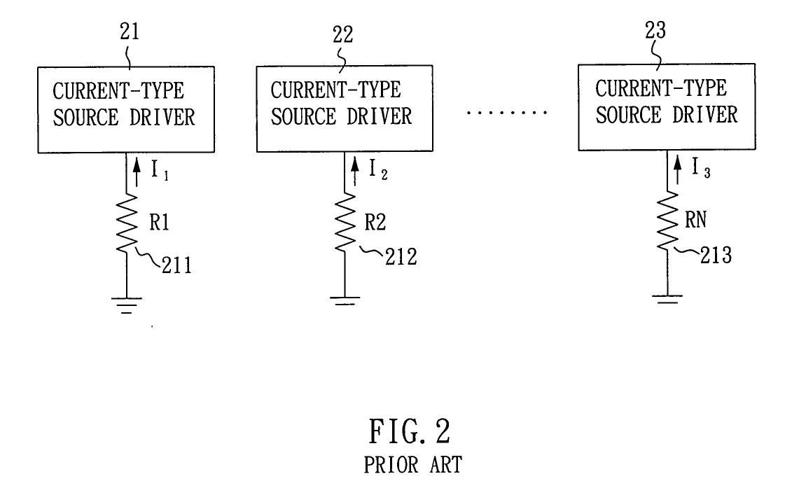

FIG. 3 is a system configuration of an embodiment of the invention;

FIG. 4 is a diagram of internal circuitry of an embodied current driver of the invention;

FIG. 5 is a schematic diagram of cascading current drivers in accordance with an embodiment of the invention; and

FIG. 6 is a diagram of internal circuitry of another embodied current driver of the invention.

### DETAILED DESCRIPTION OF THE PREFERRED EMBODIMENT

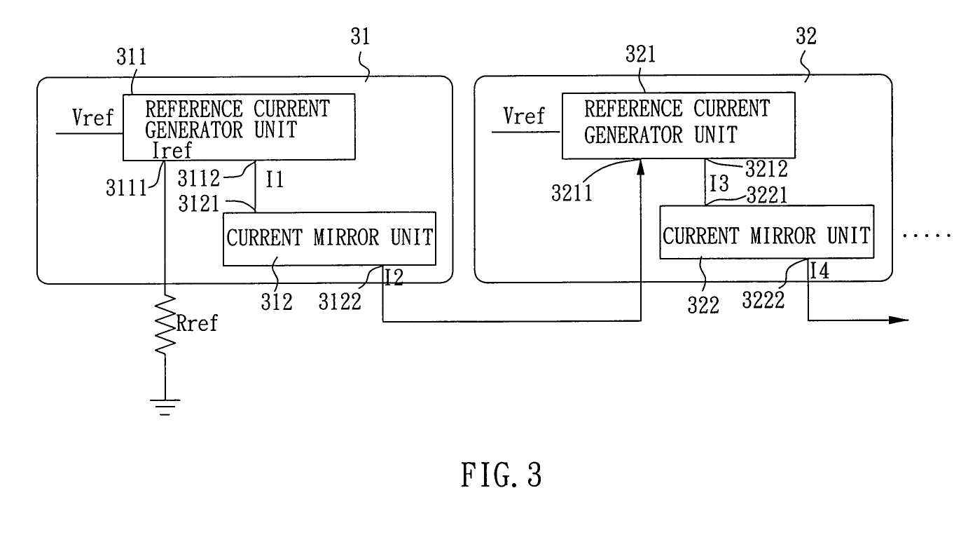

In the inventive preferred embodiment, an example of data drivers (source drivers) on an organic light-emitting diode (OLED) panel is given. In this case, data driver is a current driver. FIG. 3 shows a diagram of the inventive system configuration. In FIG. 3, the system consists of at least two current drivers 31, 32, each respectively having a reference current generator unit 311 or 321 and a current mirror unit 312 or 322. An input terminal 3111 of the reference current generator unit 311 of the first current driver 31 is externally connected to a reference resistor Rref, such that the reference current generator unit 311 can generate a reference current Iref through the reference resistor Rref and a reference voltage Vref and then generate a reference current I1 through its internal circuitry. The correlation between the reference currents Iref and I1 is described hereinafter. As cited, the invention can simply apply the reference resistor Rref to generate the reference current Iref, so that the prior different reference currents caused by variances among multiple reference resistors in use are prevented.

An input terminal 3121 of the current mirror unit 312 is connected to an output terminal 3112 of the reference current generator unit 311. An output terminal 3122 of the current mirror unit 312 is connected to an input terminal 3211 of the reference current generator unit 321 of the second current driver 32. An output terminal 3212 of the reference current generator unit 321 is connected to an input terminal 3221 of the current mirror unit 322. An output terminal 3222 of the current mirror unit 322 is connected to an input terminal of reference current generator unit of next current driver. Namely, connection between the inventive current drivers 31, 32 is cascade, such that the post-stage current driver 32 can receive an output current of the pre-stage current driver 31 for being used as the reference current Iref for operation. Operations between the current drivers 31 and 32 are further described as follows.

In the first current driver 31, the reference current generator unit 311 can generate the reference current Iref through the reference resistor Rref and the reference voltage Vref and then generate the reference current I1 through its internal circuitry. Thus, the reference current generator unit 311 can operate in accordance with the reference current I1 and accordingly generate an output driving current to drive an OLED panel. The reference voltage Vref can be provided by an external circuit or a reference voltage source generated by the current driver 31. Because the reference current generator unit 311 has the current regulating parameter K1, this results in the reference current I1=K1×Iref. The current mirror unit 312 has a current copy parameter K2 and accordingly outputs a reference current I2=K2×I1. Values of the current regulating parameter K1 and the current copy parameter K2 can be controlled by an area ratio of transistor, i.e., a ratio of W/L. The reference current I2 is inputted to the reference current generator unit 321 of the next current driver 32 as the reference current Iref.

Because the current drivers 31 and 32 are cascaded, input current received by the reference current generator unit 321 is the same as output current of the current mirror unit 312. Namely, the reference current generator unit 321 regards the reference current I2 outputted by the current mirror unit 312 as the reference current Iref. The reference current generator unit 321 has a current regulating parameter K3 and accordingly outputs a reference current I3=K3×I2. The reference currents I3 and I1 have the same value, i.e., I3=I1=K2×I2=K2×K3×I1 and K2×K3=1. As such, when K2×K3=1 is met by regulating the parameter K2 or K3, the current drivers 31 and 32 can obtain the same reference current, i.e., I1=I3.

The reference current I3 generated by the reference current generator unit 321 generates a driving current for output to drive an OLED panel and input to the current mirror unit 322 to further generate a reference current I4. The reference current I4 is outputted to next current driver (not shown) after the current driver 32. The current mirror unit 322 has a current copy parameter K4 and accordingly output a reference current I4=K4×I3.

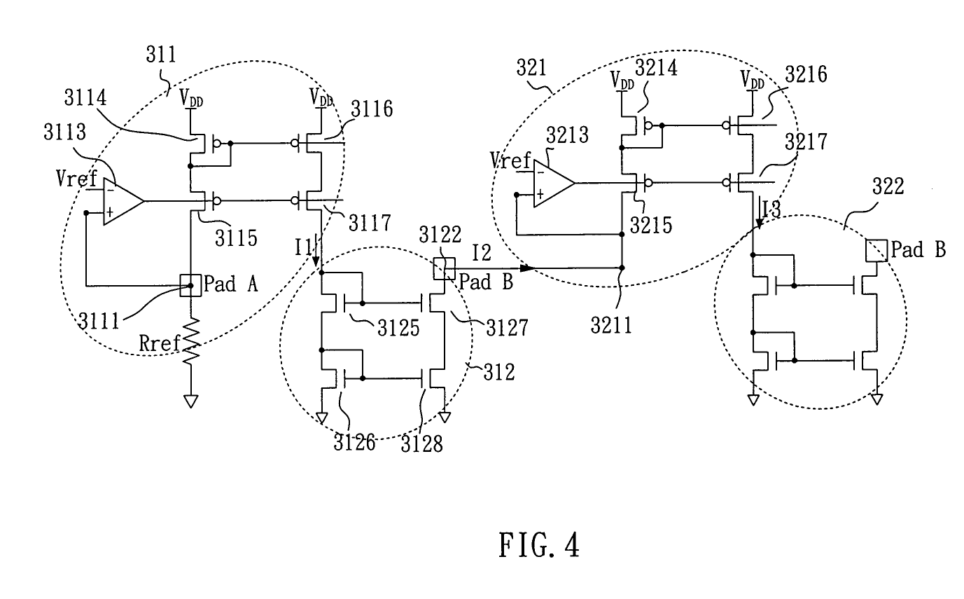

FIG. 4 shows embodied circuitry of the reference current generator units 311, 321 and current mirror units 312, 322 of the current drivers 31, 32. In FIG. 4, the reference current generator unit 311 of the current driver 31 consists of an operating amplifier 3113 and P-type metal oxide semiconductor field effect transistors (PMOSFETs) 3114, 3115, 3116, 3117. The reference current generator unit 311 firstly generates the reference current Iref. The reference current Iref is derived from the external reference resistor Rref (i.e., the reference resistor Rref is connected to a source of PMOSFET 3115) and the reference voltage Vref connected to a positive input terminal of the operating amplifier 3112. Then, the reference current generator unit 311 generates the reference current I1 through PMOSFETs 3116, 3117. A multiple (K1) between the reference currents I1 and Iref is determined by an area ratio of PMOSFETs 3114, 3115 to PMOSFET 3116, 3117.

The current mirror unit 312 is a cascade mirror circuit consisting of 4 N-type MOSFETs (NMOSFETs) 3125, 3126, 3127, 3128. A multiple (K2) of the output current I2 to input current I1 of the current mirror unit 312 is determined by geometric profile of the NMOSFETs, such as an area ratio of NMOSFET 3126 to NMOSFET 3128.

Similarly, the reference current generator unit 321 of the current driver 32 consists of an operating amplifier 3213 and PMOSFETs 3214, 3215, 3216, 3217. The unit 321 does not need to connect an external reference resistor but inputs the reference current I2 generated by the pre-stage current mirror unit 312 for generating the reference current I3 to the current mirror unit 322 as an input, which results in I3=K3×I2. A value of the regulating parameter K3 is determined by an area ratio of PMOSFETs 3214, 3215 to PMOSFETs 3216, 3217. Thus, K2×K3=1 is obtained by arranging values of the current copy parameter K2 and the current regulating parameter K3, such that the reference current I1 equals to the reference current I3.

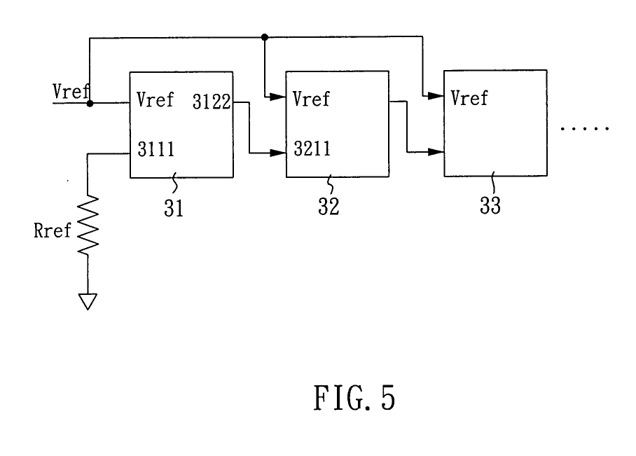

FIG. 5 shows a schematic diagram of a current driving system with more than two current drivers 31, 32, 33. In FIG. 5, current drivers 31, 32, 33 are cascaded and can unlimitedly be extended to connect other current drivers in series. As shown in FIG. 5, the current drivers 31, 32, 33 require only a reference resistor Rref (i.e., an input terminal 3111 of reference current generator unit of current driver 31 is connected to the reference resistor Rref) and a common reference voltage Vref. Output terminal 3122 of current mirror unit of a pre-stage current driver 31 is connected to input terminal 3211 of reference current generator unit of a next stage current driver 32, such that the same reference current is generated to result in the same current output, thereby obtaining frame uniformity of driven panel.

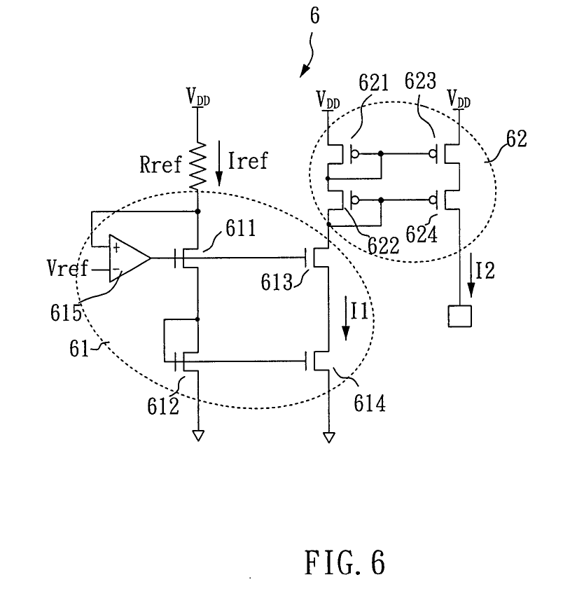

The cited PMOSFETs of the current drivers 31, 32 can be replaced with NMOSFETs, as shown in circuitry of FIG. 6. FIG. 6 is a diagram of internal circuitry of another embodied current driver 6 of the invention. Compared to FIG. 4, the same circuit features are omitted and only the different inner circuit connection for the current driver 6 is described. As shown in FIG. 6, the current driver 6 includes a reference current generator unit 61 and a current mirror 62, wherein the unit 61 further connects to an external reference resistor Rref. The reference current generator unit 61 consists of an operating amplifier 615 and NMOSFETs 611, 612, 613, and 614. The current mirror unit 62 consists of PMOSFETs 621, 622, 623, and 624. Due to the replacement between P-type and N-type MOSFETs, the reference resistor Rref is coupled between an operating voltage V_{DD} and a drain of NMOSFET 611, sources of NMOSFETs 612, 614 are grounded, and drains of PMOSFETs 621, 623 are connected to the operating voltage V_{DD}.

Cascade number of current drivers is implemented based on required resolution. Other circuitry inside the current drivers is known to those skilled in the art and thus a detailed description is deemed unnecessary.

In view of the foregoing, it is known that the invention implements a reference current generator unit and a current mirror unit in each current driver (source driver or data driver), such that current copy parameter and current regulating parameter are applied to enable different current drivers to have the same reference current and accordingly have the same output current, thereby obtaining display uniformity.

Although the present invention has been explained in relation to its preferred embodiment, it is to be understood that many other possible modifications and variations can be made without departing from the spirit and scope of the invention as hereinafter claimed.

1. A current drive system with high uniformity reference current, comprising:
a first current driver having a first reference current generator unit and accordingly generates a first current mirror unit, wherein the first reference current generator unit generates a pre-stage reference current Iref and a first reference current I1, where I1=K1*Iref and K1 is a current regulating parameter of the first reference current generator unit, and the first current mirror unit receives the first reference current I1 and accordingly generates a second reference current I2=K2*I1, where K2 is a current copy parameter of the first current mirror unit; and
at least one second current driver having a second reference current generator unit to receive the second reference current I2 and accordingly generate a third reference current I3=K3*I2, where K3 is a current regulating parameter of the second reference current generator unit and K2*K3=1.

2. The current driving system as claimed in claim 1, wherein the second current driver further includes a second current mirror unit to receive the third reference current I3 and accordingly generate a fourth reference current I4 for inputting to a next current driver.

3. The current driving system as claimed in claim 1, wherein K1=K3 and K1*K2=1.

4. The current driving system as claimed in claim 1, wherein the first reference current generator unit is externally connected to a reference resistor in order to generate the pre-stage reference current Iref according to the reference resistor and a reference voltage.

5. The current driving system as claimed in claim 1, wherein the first current driver generates a first output current in accordance with the first reference current, and the second current driver generates a second output current to drive a flat panel display's panel in accordance with the second reference current.

6. The current driving system as claimed in claim 4, wherein the first reference current generator unit has an operating amplifier and a plurality of first transistors, and the operating amplifier has a first input terminal connected to the reference voltage and a second input terminal connected to the reference resistor, thereby generating the pre-stage reference current Iref.

7. The current driving system as claimed in claim 6, wherein the first transistors are P-type metal oxide semiconductor field effect transistors (PMOSFETs).

8. The current driving system as claimed in claim 6, wherein the first transistors are N-type metal oxide semiconductor field effect transistors (NMOSFETs).

9. The current driving system as claimed in claim 1, wherein the first current mirror unit has a plurality of second transistors to form a current mirror circuit.

10. The current driving system as claimed in claim 9, wherein the second transistors are NMOSFETs.

11. The current driving system as claimed in claim 9, wherein the second transistors are PMOSFETs.

12. A current driver for cascading at least one next current driver to thus form a current drive system which provides an output current to drive a display panel, the current driver comprising:
a reference current generator unit, which generates a pre-stage reference current Iref and accordingly generates a first reference current I1=K1 *Iref, where K1 is a current regulating parameter of the first reference current generator unit; and
a current mirror unit, which receives the first reference current I1 and accordingly generates a second reference current I2=K2*I1, wherein K2 is a current copy parameter of the first current mirror unit, and the second reference current I2 is inputted to a next current driver, such that a third reference current I3=K3*I2 is generated by a reference current generator unit of the next current driver, where K3 is a current regulating parameter of the reference current generator unit of the next current driver and K2*K3=1.

13. The current driver as claimed in claim 12, wherein the reference current generator unit is externally connected to a reference resistor in order to generate the pre-stage reference current Iref according to the reference resistor and a reference voltage.

14. The current driver as claimed in claim 12, wherein K1=K3 and K1*K2=1.

15. The current driver as claimed in claim 13, wherein the reference current generator unit has an operating amplifier and a plurality of first transistors, and the operating amplifier has a first input terminal connected to the reference voltage and a second input terminal connected to the reference resistor, thereby generating the previous stage reference current Iref.

16. The current driver as claimed in claim 15, wherein the first transistors are P-type metal oxide semiconductor field effect transistors (PMOSFETs).

17. The current driver as claimed in claim 15, wherein the first transistors is N-type metal oxide semiconductor field effect transistors (NMOSFETs).

18. The current driver as claimed in claim 12, wherein the current mirror unit has a plurality of second transistors to form a current mirror circuit.

19. The current driver as claimed in claim 18, wherein the second transistors are NMOSFETs.

20. The current driver as claimed in claim 18, wherein the second transistors are PMOSFETs.
